(19) United States
(12) Patent Application Publication
(10) Pub. No.: US 2025/0337266 A1
(43) Pub. Date: Oct. 30, 2025

(54) Charging device for wirelessly charging an electrical energy store and method for controlling a charging device

(71) Applicant: BURY SP. Z. O. O., Mielec (PL)

(72) Inventor: Christian PIESCHKALLA, Bünde (DE)

(21) Appl. No.: 19/020,077

(22) Filed: Jan. 14, 2025

(30) Foreign Application Priority Data
Jan. 18, 2024 (DE) 10 2024 101 409.1

(51) Int. Cl. H02J 7/00; H01M 10/44; H02J 50/00

(52) U.S. Cl. CPC H02J 7/007192; H02J 50/005; H01M 10/44; H01M 2220/30

(57) ABSTRACT

A charging device for wirelessly charging an electrical energy store of a mobile terminal has an air channel, a support that adjoins the air channel, a contact face, an energy transmission unit for wirelessly transmitting energy to the contacted mobile terminal, at least one temperature sensor designed to measure air temperature flowing in the air channel, and a charging controller connected to the energy transmission unit that controls at least one charging parameter. The charging device is designed to control the transmission of energy from the energy transmission unit to the contacted mobile terminal based on the temperature measured by the temperature sensor.

### FIELD OF THE INVENTION

The invention relates to a charging device for wirelessly charging an electrical energy store of a mobile terminal, wherein the charging device has:
an air channel;
a support that adjoins the air channel and has a contact face for placing the mobile terminal on the contact face;
an energy transmission unit for wirelessly transmitting energy to the contacted mobile terminal;
at least one temperature sensor; and
a charging controller that is connected to the energy transmission unit and is designed to control the transmission of energy from the energy transmission unit to the contacted mobile terminal by means of the temperature measured by the at least one temperature sensor.

The invention furthermore relates to a method for controlling such a charging device.

### BACKGROUND

DE 10 2016 216 900 B1 describes a charging device for wirelessly charging a rechargeable electrical energy store of a mobile terminal with a housing, with a primary coil device and a first control device that is operatively connected thereto, wherein the first control device is arranged in the housing which has at least one air inlet opening and at least one air outlet opening. A heat sink is arranged in the housing, which heat sink has an active air supply device, i.e. a fan, assigned to it, by means of which ambient air is actively supplied to the heat sink through the at least one air inlet opening. A temperature sensor device for recording the temperature of the heat sink is assigned to the heat sink. The charging device furthermore has a second control device which is connected to the temperature sensor device in terms of signal technology and is operatively coupled to the active air supply device, and which is designed to be able to activate the active air supply device as soon as and as long as a prescribable first limit temperature of the heat sink is reached or exceeded. Moreover, the second control device is also connected to the first control device in terms of signal technology and is designed only to activate the active air supply device if wireless charging of an electrical energy store of a mobile terminal is also carried out when or after the first limit temperature of the heat sink is reached or exceeded.

DE 10 2019 211 519 A1 discloses a charging device for wirelessly charging an electrical energy store of a mobile terminal for a motor vehicle, wherein the charging device has charging electronics and a housing in which the charging electronics are arranged. The housing comprises a contact region for contacting the mobile terminal, wherein the contact region has at least two elevations which extend in the direction of the length of the contact region and have a respective first predetermined height, which are arranged parallel at a predetermined distance from one another and form an air channel when the mobile terminal is in place. The housing has at least one air inlet opening and at least one air outlet opening, wherein the air outlet opening is arranged in the contact region and is configured to blow air out of the air channel. Furthermore, at least one barrier is arranged in the air channel, which barrier swirls the air blown out of the air channel.

The charging of mobile devices via inductive transmission of energy has become increasingly important. Similarly to wired charging, where the mechanical and electrical standard via the micro USB or USB-C interface has become established, there is also a transmission standard in the case of the inductive transmission of energy, which standard makes it possible to combine charging devices and mobile terminals of different manufacturers. In the world of wireless charging, the Qi standard of the WPC (Wireless Power Consortium) has become established and is now supported by all the most well-known manufacturers of mobile devices. This standard offers a defined transmission of power of up to 5 watts in the low-power range and up to 15 watts in the medium-power range.

Some mobile device manufacturers have expanded this standard for specific cell phones and are thus able to transmit power above 15 watts. During the charging process, in which electrical energy is converted into magnetic energy in the energy transmitter and then magnetic energy is converted back into electrical energy in the mobile device to be charged, losses occur in various circuit units both from the transmitter and from the mobile device, which losses are released in the form of heat energy. The higher the transmitted power, the higher also is the power loss and thus the heat production.

The electrical energy is typically stored in lithium-ion batteries in the mobile device, and the charging should take place only up to a temperature of approximately 45° C. in accordance with the specification of this type of battery, in order to achieve the longest possible service life of the accumulator and to protect the accumulator from hazardous operating states which lead to a possible fire, for example. This protective functionality is typically implemented in the mobile device itself, which is equipped with a temperature sensor in the vicinity of the accumulator.

Owing to the not inconsiderable consequences of faulty temperature protection in the mobile device, it is necessary to install a further protective function in the charging device. Even if the charging is carried out at room temperature as the ambient temperature, the accumulator heats up very quickly to the maximum permissible temperature as a result of the high losses in the transmitter and in the mobile device. Now, in order to stop the temperature increase, either the charging output must be reduced or the charging must be switched off completely or active cooling must take place.

Cooling methods are known which use the air flowing out of the air conditioning system of the vehicle, or methods with a fan integrated into the transmitter, wherein ambient air is blown or sucked through between the transmitter contact face and the mobile device. Furthermore, however, it must be checked whether the temperature exceeds the critical temperature threshold despite the air cooling. To this end, typically one or more temperature sensors are accommodated in or just below the contact face of the transmitter. These sensors record both a temperature increase through the power components in the transmitter and a temperature increase in the mobile device to be charged caused by the losses in the receiver electronics, the charging losses in the accumulator and the heat generation in the processor for the actual functioning of the mobile device, e.g. navigation.

Recording of the temperature increase in the mobile device by the temperature sensor in the charging device traditionally happens as follows: heat energy is passed from the contact side of the mobile device through the contact pad of the charging device via the plastics housing face of the charging device to the temperature sensor below the plastics housing face. Since both the contact pad and the plastics housing possess a thermal resistance, a temperature drop occurs via the direction of the flow of heat, such that the temperature of the mobile device is higher than the temperature at the sensor. If the material constants of housing wall and contact pad are known, the system can infer the temperature in the handset and reduce the charging output if the calculated temperature in the mobile device exceeds a determined limit value. If the charging device can be used both with and without a contact pad or different contact pads can be used, it is not possible to calculate a sufficiently accurate temperature of the mobile device.

A further inaccuracy consists in the fact that these temperature sensors are placed very close to the transmitting coils and also heated by them. Therefore, it can happen that too high a temperature is calculated for the mobile device and the transmission power is reduced, even though the mobile device has not yet reached the critical temperature.

### SUMMARY

It is an object of the present invention to provide an improved charging device and an improved method for controlling the charging process using such a charging device.

The object is achieved by the charging device having the features of claim 1 and by the method having the features of claim 9. Advantageous embodiments are described in the dependent claims.

It is proposed that the at least one temperature sensor is designed to measure the air temperature of the air flowing in the air channel and the charging controller is designed to control at least one charging parameter for the energy transmitted from the energy transmission unit and/or the airflow of the air flowing in the air channel by means of the temperature of the mobile terminal, wherein the temperature of the mobile terminal is determined as a measure of the increase in the air temperature of the air flowing in the air channel past the contact face with the mobile terminal placed thereon, which occurs from the entry of the air before the region of the contact face to the exit after the region of the contact face.

The problem of inaccurate determination of the temperature of the mobile terminal using unknown material constants and associated heat resistances between mobile terminal and temperature sensor is solved by the fact that an airflow is sucked through between the mobile terminal and the contact face and thereafter the temperature of the air is measured.

Therefore, a wireless energy transmitter (“Wireless Charging Transmitter”) is provided, which possesses an airflow cooling system for the energy transmitter and/or contacted mobile device and in which the temperature of the mobile device and/or energy transmitter is recorded by measuring the temperature of the air that has flowed through. The information regarding the temperature is used to control at least one charging and/or venting parameter, so that the charging time is optimized and/or the mobile device can be protected against overtemperature.

The mobile terminal rests on the contact face of the charging device. In this case it is preferably envisioned that the mobile terminal does not rest directly over the entire area, but rather rests at an appropriate distance from the charging surface using measures such as e.g. spacers on the charging surface. An air gap is therefore produced between the charging surface or the air channel base and the mobile terminal. An air passage opening within the contact face forms an air channel below the mobile terminal using further guide elements, via which air channel ambient air is flowed through the air channel past the lower side of the mobile terminal, via which lower side energy is also exchanged wirelessly, and reaches the interior of the charging device through the air passage opening. The slightly heated air can be used to further cool the electronics there or can reach the outside directly via an air outlet opening. The airflow is typically brought about by an electrically driven fan situated in the charging device. The air can be sucked out of the air channel or blown into the air channel.

A temperature sensor is situated in the air channel in the region of the air passage opening, which temperature sensor adopts the temperature of the heated air after said air has flowed around it and transmits a value corresponding to the temperature to the charging controller. The charging controller can be implemented in a software-controlled manner using a microprocessor or microcontroller of the charging device.

The heat energy is transmitted from the lower side of the mobile terminal to the air below the mobile terminal by means of the physical principle of heat conduction and absorbed by the air that has a determined specific heat capacity and stored. Here, the following applies: the higher the temperature difference between the lower side of the mobile device and the air, the more heat energy is transmitted to the air and stored thereby. The following also applies: the longer the air remains below the mobile device, the more heat energy is transmitted and the more the air heats up.

Therefore, the following relationships apply:
the heating of the air is approximately proportional to the temperature difference between the lower side of the mobile terminal and the sucked-in ambient air;
the heating of the air is approximately inversely proportional to the airflow rate.

The airflow rate is dependent on the shape of the air channel and on the air throughput of the fan. These values are known and change during the service life of the charging device. The air throughput of the fan is dependent on its speed of rotation. This is prescribed by the level of the activation voltage of the charging electronics and is therefore also known.

A first temperature sensor can be arranged before the contact face in the air channel in the direction of airflow and a second temperature sensor can be arranged after the contact face in the air channel in the direction of airflow. The charging controller can be designed to determine the increase in the air temperature from the difference between the temperatures measured using the first and second temperature sensor. Therefore, the abovementioned first relationship is utilized to determine the increase in the air temperature and thus to determine the heat energy transmitted from the mobile terminal.

The air supplied to the air channel before the transmission of heat by the mobile terminal has a temperature that is measured by the first temperature sensor. This first temperature corresponds to the a priori unknown temperature of the ambient air, which can be determined by measuring with the second temperature sensor before the start of charging or with the mobile device not in place, by a first temperature sensor arranged before the contact face in the air channel in the direction of airflow, or by an air conditioning device that regulates the ambient temperature. Since the temperature of the ambient air in modern motor vehicles is maintained constantly at approximately 20° C. to 25° C. by the air conditioning units, this value can simply be adopted. Relatively significant deviations are to be expected only at the beginning of a journey, if the vehicle has completely cooled down in winter, for example, or has been exposed to direct sunlight in summer.

Therefore, the following relationship can be assumed:

$$Δ {T}_{air} ∼ ( proportional to ) ( {T}_{mobile device} - 22 °C . ) / {U}_{fan} .$$

The temperature difference ΔTₐᵢᵣ in the air flowing past the mobile terminal that is a measure of the quantity of absorbed heat can be determined from the temperature difference between the air temperature T_{mobile device} flowing out after the mobile terminal in the direction of flow and the adopted ambient temperature of 22° C., for example, which is flowing in before the mobile terminal in the direction of flow, and the fan voltage U_{fan}. The fan voltage U_{fan} is the activation voltage of the fan, which is proportional to the airflow rate or airflow speed that passes the mobile terminal.

If all constant values dependent on the system are summarized in a constant K, the result is:

$$Δ {T}_{air} = {K}^{*} ( {T}_{mobile device} - 22 °C . ) / {U}_{fan} .$$

When converted, the temperature of the mobile terminal gives:

$${T}_{mobile device} = Δ {{T}_{air}}^{*} {U}_{fan} / K + 22 °C ..$$

It is also clear from the converted formula that the calculation of the temperature of the mobile terminal crucially depends on how accurately the increase in the air temperature can be determined, in particular how accurately the temperature of the sucked-in ambient air can be measured or calculated.

The temperature increase is typically only a few degrees ° C. at the corresponding fan speed. For this, a first temperature sensor can be fitted in the air channel in a position where the air has not yet been heated by the mobile device. The measured temperature at this sensor then corresponds to the ambient air. The formula would change as follows:

$${T}_{mobile device} = {( {T}_{air} - {T}_{ambient} )}^{*} {U}_{fan} / K + {T}_{ambient} .$$

With the two sensors, the temperature of the mobile device can now be calculated with sufficient accuracy. One disadvantage, however, is that two temperature sensors are required for this.

The charging device can have a fan that is communicatively connected to the air channel. Thus, the airflow and in particular the airflow speed, i.e. the volume of air flowing directly or indirectly past the mobile terminal per unit of time, can be varied by changing the fan speed. This is also equivalent to the optional switching on or off of a plurality of fans connected in parallel or the timed activation of one or more fans. With the variation of the airflow rate, the abovementioned second relationship is utilized to determine the increase in the air temperature and thus to determine the heat energy transmitted from the mobile terminal.

The temperature difference in the air flowing past the mobile terminal can be measured with two different fan speeds or fan activation voltages U_{fan1} and U_{fan2}. For this purpose, the charging controller can be designed to activate the fan to bring about a first airflow speed, which corresponds to the airflow rate past the mobile terminal, of the airflow in the air channel and to measure the first air temperature at the first airflow speed, to activate the fan to bring about a second airflow speed of the airflow in the air channel and to measure the second air temperature at the second airflow speed and to determine the increase in the air temperature from the difference between the measured first and second air temperature.

The formula is basically the same as the one listed above. However, the ambient temperature is not known and also does not need to be measured, estimated or supplied. The two airflow speeds or fan activation voltages U_{fan1} and U_{fan2} result in the following two formulae:

$${T}_{mobile device} = {( {T}_{air 1} - {T}_{ambient} )}^{*} {U}_{fan 1} / K + {T}_{ambient}$$

$${T}_{mobile device} = {( {T}_{air 2} - {T}_{ambient} )}^{*} {U}_{fan 2} / K + {T}_{ambient} .$$

Subtracting the equations and then multiplying by K gives:

$$0 = {( {T}_{air 1} - {T}_{ambient} )}^{*} {U}_{fan 1} - {( {T}_{air 2} - {T}_{ambient} )}^{*} {U}_{fan 2}$$

or when converted

$${( {T}_{air 1} - {T}_{ambient} )}^{*} {U}_{fan 1} = {( {T}_{air 2} - {T}_{ambient} )}^{*} {U}_{fan 2}$$

Further conversion gives:

$${{T}_{air 1}}^{*} {U}_{fan 1} - {{T}_{ambient}}^{*} {U}_{fan 1} = {{T}_{air 2}}^{*} {U}_{fan 2} - {{T}_{ambient}}^{*} {U}_{fan 2}$$

Converted to T_{ambient} gives:

$${{T}_{air 1}}^{*} {U}_{fan 1} - {{T}_{air 2}}^{*} {U}_{fan 2} = {{T}_{ambient}}^{*} {U}_{fan 1} - {{T}_{ambient}}^{*} {U}_{fan 2}$$

$${T}_{ambient} = ( {{T}_{air 1}}^{*} {U}_{fan 1} - {{T}_{air 2}}^{*} {U}_{fan 2} ) / ( {U}_{fan 1} - {U}_{fan 2} ) .$$

The temperature of the ambient air can thus be calculated and can be inserted into the original formula (T_{mobile device}=(Tₐᵢᵣ₁−T_{ambient})*U_{fan1}/K+T_{ambient}) and therefore the temperature increase and the temperature of the mobile device can also be determined with sufficient accuracy.

This leads to the following formula:

$${T}_{mobile device} = {( {T}_{air 1} - {T}_{ambient} )}^{*} {U}_{fan 1} / K + {T}_{ambient} = {{T}_{air 1}}^{*} {U}_{fan 1} / K - {{T}_{ambient}}^{*} {U}_{fan 1} / K + {T}_{ambient} = {{T}_{ambient}}^{*} ( 1 - {U}_{fan 1} / K ) + {{T}_{air 1}}^{*} {U}_{fan 1} / K = ( {{T}_{air 1}}^{*} {U}_{fan 1} - {{T}_{air 2}}^{*} {U}_{fan 2} ) / {( {U}_{fan 1} - {U}_{fan 2} )}^{*} ( 1 - {U}_{fan 1} / K ) + {{T}_{air 1}}^{*} {U}_{fan 1} / K .$$

In this method based on different fan speeds, two extreme cases are conceivable:
a) a very high air speed, wherein the air virtually cannot heat up at all and the measured temperature corresponds approximately to the ambient air, and
b) a very low air speed, wherein the air remains for a very long time below the mobile device and heats almost to the temperature of the mobile device. In this case, however, there would be hardly any cooling effect.

It is therefore advantageous if cyclical measurement intervals are provided, in which the fan runs very slowly, wherein the measured temperature is adopted as the mobile device temperature. This makes complex calculation of the mobile device temperature superfluous. This method with cyclical measurement intervals can be used in addition or alternatively to the above-described methods.

In this regard, the charging controller can be designed to cyclically activate the fan at measurement intervals to bring about a reduced airflow speed of the airflow in the air channel and to measure the air temperature at the measurement interval at the reduced airflow speed and to determine the temperature of the mobile terminal proportionally to the air temperature measured at the measurement interval. The reduction in the airflow speed can also be brought about by switching the fan off. The airflow can therefore substantially be limited to a natural convective airflow.

The charging controller can be designed to reduce or switch off the charging output and/or to increase the airflow speed by controlling at least one charging parameter for the energy transmitted from the energy transmission unit.

If it is found that the temperature of the mobile terminal exceeds a determined limit temperature, measures can be undertaken by the charging electronics of the charging controller and/or of the mobile terminal, in order to prevent a further temperature increase or to cause a drop in temperature. These measures can be:
reducing the charging output;
switching off the charging output;
increasing the fan speed.

The method for controlling such a charging device for wirelessly charging an electrical energy store of a mobile terminal has the steps:
measuring the temperature of the air that flows directly or indirectly past the mobile terminal in the air channel that adjoins a contacted mobile terminal, and
controlling at least one charging parameter for energy transmission using the energy transmission unit and/or the airflow of the air flowing in the air channel by means of the increase in the air temperature of the air flowing in the air channel past the contact face with the mobile terminal placed thereon, which occurs from the entry of the air before the region of the contact face to the exit after the region of the contact face.

A first temperature can be measured in the air channel in the direction of airflow before the contact face and a second temperature can be measured in the air channel in the direction of airflow after the contact face and the increase in the air temperature can be determined from the difference between the first and second temperature.

The method can have the steps of:
activating the fan to bring about a first airflow speed of the airflow in the air channel and measuring the first air temperature at the first airflow speed,
activating the fan to bring about a second airflow speed of the airflow in the air channel and measuring the second air temperature at the second airflow speed and
determining the increase in the air temperature from the difference between the measured first and second air temperature.

At least one charging parameter for the energy transmitted from the energy transmission unit can be controlled to reduce or switch off the charging output and/or the airflow of the air flowing in the air channel can be controlled by means of the increase in the air temperature of the air flowing in the air channel past the contact face with the mobile terminal placed thereon, which occurs from the entry of the air before the region of the contact face to the exit after the region of the contact face.

### DESCRIPTION OF THE DRAWINGS

The invention will be explained hereinafter by way of example with reference to exemplary embodiments using the accompanying drawings. In the drawings:

FIG. 1—shows a lateral sectional view of a charging device for wirelessly charging an electrical energy store of a mobile terminal;

FIG. 2—shows a perspective plan view of a support with air channel in the contact face;

FIG. 3—shows a perspective plan view of another embodiment of the contact face;

FIG. 4—shows an enlarged detail view of the perspective rear view from FIG. 3.

### DETAILED DESCRIPTION

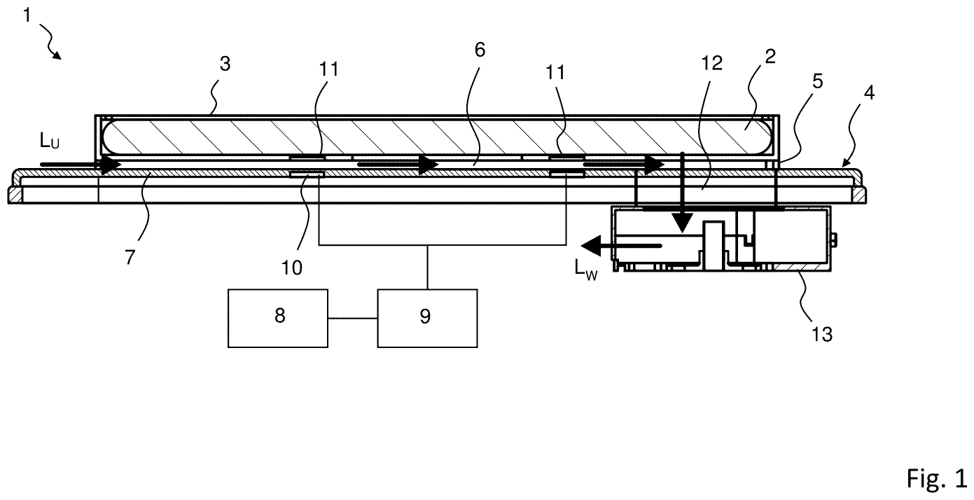

FIG. 1 shows a lateral sectional view of a charging device 1 for wirelessly charging an electrical energy store 2 of a mobile terminal 3.

There is a support 4 with a contact face 5 on which the mobile device 3 rests. It can be seen that an air channel 6 in the form of an air gap between the lower side of the mobile terminal 3 and an air channel base 7 of the support 4 is situated between the contact face 5 and the mobile terminal 3, through which air channel 6 the ambient air Aₐ is sucked. Optionally, the ambient air Aₐ can also be blown through the air channel 6 in the reverse direction of flow.

The charging device 1 has a charging controller 8 and, attached thereto, an energy transmission unit 9 with at least one transmitting coil 10 that is arranged on the support 4. The mobile terminal 3 has a corresponding receiving coil 11 adjacent to the at least one transmitting coil 10, in order to receive the electromagnetic field produced by the transmitting coil 10. The energy transmission unit 9 is configured to wirelessly charge the electrical energy store 2 (in particular an accumulator) of the mobile terminal 3 with the aid of the energy absorbed from the charging device 1 via the receiving coil 11. For this purpose, there can also be a wireless communication interface, for exchanging charging parameters between the charging controller 8 of the charging device and a charging controller (not depicted) of the mobile terminal 3. This can take place in the rear channel by signaling via the receiving coil 11 to the transmitting coil 10, for example by briefly changing the load applied at the receiving coil 11.

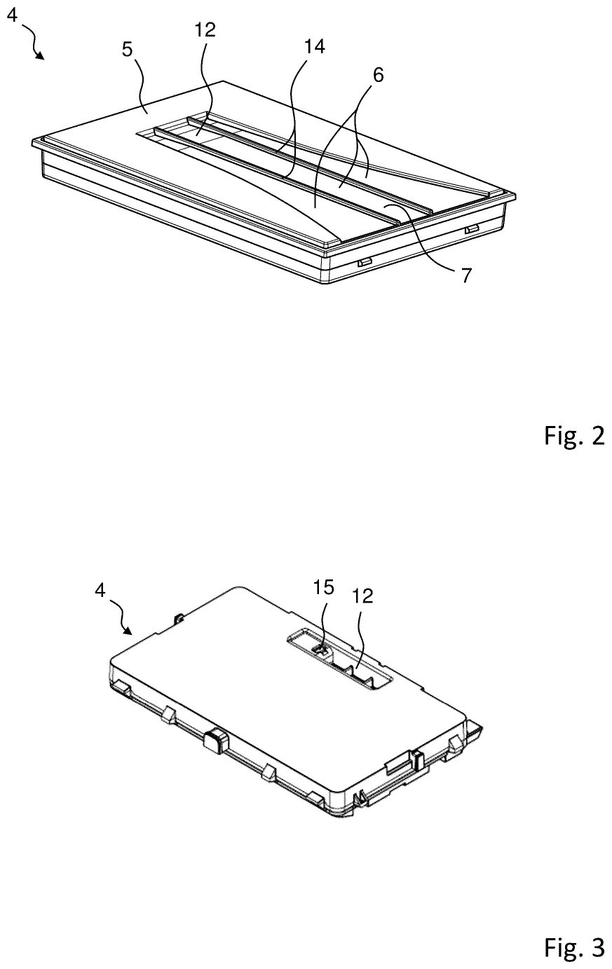

The air A flows along the lower side of the mobile terminal 3 and is heated up by the heat of the mobile terminal 3. The now-heated air Aₙ is sucked into the interior of the charging device 1 via an air passage opening 12 in the contact face 5, guided through a fan 13 and released to the environment again at another location. The air passage opening 12, through which the heated air Aₙ is sucked out of the air channel 6 into the charging device 1, can be situated at different locations. The air passage opening 12 close to the end face of the charging device 1 is depicted in FIGS. 1 and 2. By contrast, the air passage opening 12 is situated on one side in FIG. 3.

FIG. 2 shows a perspective plan view of the support 4 of the charging device 1 with air guidance channels 6 incorporated into the contact surface 5. These are delimited by an air channel base 7 and support webs 14. It can clearly be seen that the structure of the contact face 5 together with the lower side of a contacted mobile device 3 form three airflow channels 6 which end at the air passage opening 12. What is not depicted is the fan 13, which is situated below the air passage opening 12 and sucks air Aₐ into the charging device 1 or blows it into the air guidance channels 6. In this respect, depending on the direction of airflow, the air passage opening 12 can be an air inlet opening or an air outlet opening. The ambient air Aₐ, which is sucked from below the mobile device 3, is heated both by the higher temperature of the mobile device 3 and the possibly higher temperature of the contact face 5, wherein the temperature increase is caused by the losses from the transmitting coil 10.

If there is a metallic foreign body in the air channel 6, for example a paperclip or a small coin that is heated by the eddy currents, then this also ensures that the sucked-in air Aₐ is heated. In this case, the calculated temperature T_{mobile device} of the mobile terminal 3 would not correspond to the temperature of the mobile device 3, but the result of the reduction in the output or switching-off of the output is also desirable, in order to avoid a hazard due to excessive heating of the foreign body.

FIG. 3 shows a perspective view of another embodiment of the support 4 of a charging device 1. The air passage opening 12 can be seen, which is arranged on one side of the air channel 6 in this exemplary embodiment. A support pad, not depicted, is placed on the surface, which support pad is fashioned with openings and webs such that the air below the mobile device 3 placed thereon is led into the air passage opening 12 of the support 4. A temperature sensor 15 is arranged on one side of the air passage opening 12, which temperature sensor 15 measures the temperature of the heated air Aₙ in the direction of flow after the mobile terminal 3.

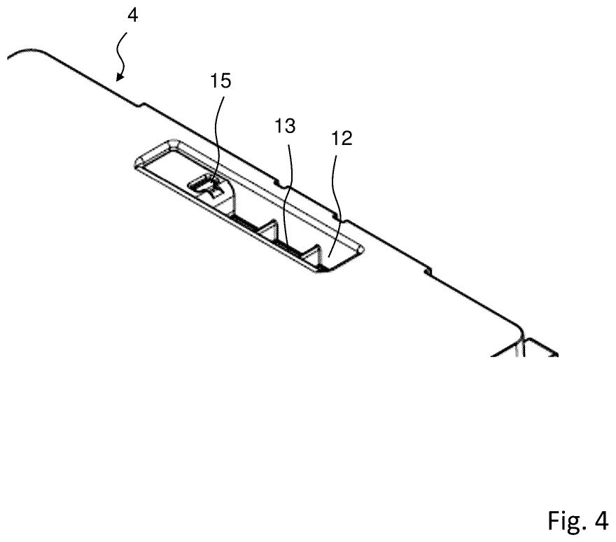

FIG. 4 shows this region again, enlarged. The heated air Aₙ flows past the temperature sensor 15 and also heats it to the temperature level of the heated air Aₙ. If there is no mobile terminal 3 in place, the temperature sensor 15 records the ambient temperature of the ambient air Aₐ at the location of the contact face 5. This does not necessarily have to be the interior temperature of a vehicle in which the charging device 1 may be installed, since the contact face 5 could still be heated from the previous charging process. In order to reliably record the air temperature in the interior of the vehicle, the fan 13 can be switched on, even though there is no mobile terminal 3 in place, so as to suck in interior air directly. When there is a mobile terminal 3 in place, the sucked-in ambient air Aₐ is heated by the mobile terminal 3, from below which it is sucked or blown. This temperature difference between the temperature of the ambient air Aₐ and the heated air Aₙ is therefore a measure of the temperature of the mobile device. This temperature difference represents the heat absorption by the mobile terminal 3.

Depending on preliminary requirements, the following possibilities for the method for cooling and protecting the mobile terminal 3 are advantageous:
1. There is no mobile device 3 in place on the contact face. The ambient temperature can then be recorded continuously.
2. A mobile device is placed on the contact face and the charging begins. The fan 13 is then switched on at a predetermined speed. Depending on the measured air temperature and the temperature of the mobile terminal 3 calculated therefrom, the fan 13 is regulated in terms of its speed.
3. The mobile terminal 3 is charged and heats up. If the calculated temperature of the mobile terminal 3 is above a first critical value despite the fan being at maximum speed, the charging output is reduced. If the calculated temperature of the mobile terminal 3 is above a second critical value despite the fan being at maximum speed, the charging is switched off completely.

### LIST OF REFERENCE SIGNS

1 charging device
2 electrical energy store
3 mobile terminal
4 support
contact face
6 air channel
7 air channel base
8 charging controller
9 energy transmission unit
transmitting coil
11 receiving coil
12 air passage opening
13 fan
14 support webs
temperature sensor
Aₐ ambient air
Aₙ heated air

1. A charging device for wirelessly charging an electrical energy store of a mobile terminal, comprising:
an air channel;
a support that adjoins the air channel, wherein the support has a contact face for placing the mobile terminal on the contact face to create a contacted mobile terminal;
an energy transmission unit for wirelessly transmitting energy to the contacted mobile terminal;
at least one temperature sensor; and
a charging controller connected to the energy transmission unit, wherein the charging controller is designed to control the transmission of energy from the energy transmission unit to the contacted mobile terminal based at least in part on the temperature measured by the at least one temperature sensor;
wherein the at least one temperature sensor is designed to measure air temperature of air flowing in the air channel, wherein and the charging controller is designed to control at least one charging parameter for energy transmitted from the energy transmission unit and/or the airflow of the air flowing in the air channel.

2. The charging device as claimed in claim 1, wherein the charging controller controls the at least one charging parameter for the energy transmitted from the energy transmission unit and/or controls the airflow of the air flowing in the air channel based at least in part on a temperature of the mobile terminal, wherein the temperature of the mobile terminal is determined as a measure of an increase in the air temperature of the air flowing in the air channel past the contact face with the mobile terminal placed thereon, which occurs from the entry of the air before the region of the contact face to the exit after the region of the contact face.

3. The charging device as claimed in claim 2, wherein the at least one temperature sensor comprises a first temperature sensor is arranged in the air channel in a direction of airflow after the contact face, and wherein and the charging controller is designed to determine the increase in the air temperature from a difference between the temperature measured using the first temperature sensor and a measured ambient temperature adopted as an estimated variable or supplied by the charging device.

4. The charging device as claimed in claim 3, wherein the at least one temperature sensor comprises a second temperature sensor is arranged in the air channel in the direction of airflow before the contact face, and wherein the charging controller is designed to determine the increase in the air temperature from the difference between the measured ambient temperature and the temperature measured using the first temperature sensor and a temperature measured using the second temperature sensor.

5. The charging device as claimed in claim 1, further comprising a fan communicatively connected to the air channel.

6. The charging device as claimed in claim 5, wherein the charging controller is designed to activate the fan to bring about a first airflow speed for of the airflow in the air channel and to measure a first air temperature at the first airflow speed, wherein the charging controller is designed to activate the fan to bring about a second airflow speed of the airflow in the air channel and to measure a second air temperature at the second airflow speed, and wherein the charging controller is designed to determine the temperature of the mobile terminal or the increase in the air temperature from the difference between the measured first air temperature and the measured second air temperature.

7. The charging device as claimed in claim 5, wherein the charging controller is designed to cyclically activate the fan at measurement intervals to bring about a reduced airflow speed of the airflow in the air channel and to measure the air temperature at a selected measurement interval at the reduced airflow speed and to determine the temperature of the mobile terminal proportionally to the air temperature measured at the selected measurement interval.

8. The charging device as claimed in claim 1, wherein the charging controller is designed to reduce or switch off a charging output and/or to increase an airflow speed by controlling at least one charging parameter for the energy transmitted from the energy transmission unit.

9. A method for controlling a charging device as claimed in claim 1, comprising:
measuring an air temperature of air that flows directly or indirectly past a mobile terminal in the air channel that adjoins a contacted mobile terminal, and
controlling at least one charging parameter for energy transmission using the energy transmission unit and/or controlling airflow of the air flowing in the air channel based at least in part on the measured air temperature.

10. The method for controlling a charging device as claimed in claim 9, wherein controlling the at least one charging parameter for energy transmission using the energy transmission unit and/or the airflow of the air flowing in the air channel comprises measuring an increase in air temperature of the air flowing in the air channel past the contact face with the mobile terminal placed thereon, which occurs from an entry of the air before a region of the contact face to an exit after the region of the contact face.

11. The method as claimed in claim 10, wherein measuring the increase in the air temperature of the air flowing in the air channel comprises measuring a first temperature in the air channel in a direction of airflow after the contact face, and determining the increase in the air temperature from a difference between a measured first temperature and a measured ambient temperature adopted as an estimated variable or supplied by the charging device.

12. The method as claimed in claim 10, wherein the increase in the air temperature of the air flowing in the air channel comprises measuring a first temperature in the air channel in the direction of airflow before the contact face as a variable that is proportional to the ambient temperature and determining the increase in the air temperature from a difference between the first temperature and a second temperature which is the ambient temperature.

13. The method as claimed in claim 10, further comprising
activating a fan to bring about a first airflow speed of the airflow in the air channel and measuring a first air temperature at the first airflow speed,
activating the fan to bring about a second airflow speed of the airflow in the air channel and measuring a second air temperature at the second airflow speed, and
determining a temperature of the mobile terminal or an increase in the air temperature from the difference between the measured first air temperature and the measured second air temperature.

14. The method as claimed in claim 9, further comprising cyclical activation of a fan at measurement intervals to bring about a reduced airflow speed of the airflow in the air channel, measuring an air temperature present at a selected measurement interval at the reduced airflow speed, and determining a of the temperature of the mobile terminal proportionally to the air temperature measured at the selected measurement interval.

15. The method as claimed in claim 9, wherein control of the at least one charging parameter for the energy transmitted from the energy transmission unit is performed so as to reduce or switch off the charging output and/or control of the airflow of the air flowing in the air channel to cause an increase in the air temperature of the air flowing in the air channel past the contact face with the mobile terminal placed thereon, which occurs from the entry of the air before a region of the contact face to the exit after the region of the contact face.
